(19) United States
(12) Patent Application Publication
(10) Pub. No.: US 2005/0234791 A1
(43) Pub. Date: Oct. 20, 2005

(54) Premium financing method and loan product using life insurance policies and method for administering same

(76) Inventor: Michael Krasnerman, Stamford, CT (US)

Correspondence Address: FULBRIGHT & JAWORSKI, LLP, 666 FIFTH AVE, NEW YORK, NY, 10103-3198, US

(21) Appl. No.: 11/098,907

(22) Filed: Apr. 4, 2005

Related U.S. Application Data
(60) Provisional application No. 60/558,875, filed on Apr. 2, 2004.

(51) Int. Cl. G06F 17/60

(52) U.S. Cl. 705/35; 705/4

(57) ABSTRACT

A premium financing method and a non-recourse loan product using life insurance policy as only collateral for a non-recourse loan. The proceed of the non-recourse loan being used to pay the premium of the life insurance policy. The non-recourse loan product can use a new or an existing life insurance policy of the insured to provide reverse life settlement.

### RELATED APPLICATIONS

This application claims priority to the U.S. Provisional Application Ser. No. 60/558,875 filed Apr. 2, 2004, which is incorporated by reference in its entirety.

### BACKGROUND OF THE INVENTION

The present invention relates to a premium financing method and loan product using life insurance policies and a method for administering same, more particularly to a non-collateralized-based premium financing method and non-recourse loan product using life insurance policies as asset backed collateral and a method for administering same.

It is estimated that hundreds of thousands of high-net-worth seniors possess unused insurance capacity. As individuals age and their net worth presumably increases, there is a greater likelihood that the insurance policies issued earlier in their lives provide less coverage than most professional financial planners would recommend. Until now, high-net-worth seniors, particularly seniors over 70 years of age and suffering from one or more adverse medical conditions, have had very little opportunity to change this situation and maximize their insurance capacity or potential death benefits.

The cost of new high face value life insurance policies for such individuals is often expensive, even for the affluent, and there is often a reluctance to tie up financial resources in paying large premiums on such policies. Additionally, seniors' liquidity situations may be very unclear or in flux due to a variety of complex personal, estate settlement and/or business ownership circumstances. In general, the financial burden or near-term liquidity concerns limit the ability to maximize unused capacity.

Currently, the insured has very little opportunity to maximize his or her insurance capacity or potential death benefits without incurring significant cost. The premium payments for maximum insurance coverage are generally onerous and costly for most insured. The insured can either underutilize their insurance capacity or pledge their liquid assets as collateral to borrow funds to pay for these costly premiums. Typically, the insured must borrow funds against the premiums and pledge asset(s) equivalent in value to back the borrowed funds or sums of money. The borrowed funds are generally subject to a call provision. Additionally, the principal and interest can be due at time certain (or uncertain) creating a burden on the owner/insured. Thus, most insured currently do not fully utilize their insurance capacity.

The pledged assets are typically liquid assets, thereby effectively freezing these liquid assets and making them less liquid. It is appreciated that pledging such assets can create havoc to the owner/insured upon a call or repayment. Any downturn in the owner/insured's assets (such as a stock market downturn or bear market) can potentially trigger a call, wherein the insured's inability to repay the borrowed fund can create a potential foreclosure situation. It is not uncommon, particularly in economic downturn, for many insurance policies to be on the verge of surrender or sale because the pledges can no longer be fulfilled with easily available liquid assets.

Therefore, it is desirable to provide a method and product for financing insurance policies without pledging assets of the insured, thereby avoiding the problems noted hereinabove. The present invention advantageously enables the insured/owner to maximize their insurance capacity without locking up their liquid assets. This additionally provides the insured with more flexibility with their financial, retirement, charitable giving and estate planning.

### SUMMARY OF THE INVENTION

It is therefore an object of the present invention to provide a premium financing method and loan product using life insurance policies as asset backed collateral (or “LIF” loan product), and a method for administering the LIF loan product. With the policies themselves serving as the only collateral for the non-recourse loans and the reduction of burdensome up-front costs for new life insurance policies, prospective borrowers are able to purchase valuable life insurance coverage with minimal upfront dedication of personal capital.

In accordance with an embodiment, the present invention utilizes the actual policy as the collateral for the financing. The present invention utilizes a form of predictive arbitrage to determine and qualify the insured for such premium financing. This form of predictive arbitrage can utilize known or proprietary evaluation models to determine the value of the insurance policy at the end of the term (the termination value) and insured's ability to repay the non-recourse loan based on the termination value of the policy. The predictive arbitrage of the present invention can use insured's financial ability, health status, future marketplace value of the policy, etc. to determine the termination value of the insurance policy and insured's ability to repay the non-recourse loan.

The present invention advantageously enables the lender to financially underwrite the insurance policy using predictive arbitrage. For example, arbitrage opportunities can occur when policies written for older adults are influenced by marker forces which include insurance companies' near-term objectives regarding new policy, new premium volume, and different pricing criterias. Hence, policies are competitively shopped in the marketplace and placed advantageously with a carrier willing to underwrite the insured's impaired health and age at extremely favorable rates. Additional factors affecting pricing on policies include: the fact that insurance companies may interpret the seriousness of various medical conditions differently; the internal rate of return (IRR) requirements and investment risk parameters of insurance companies vary industry wide; the classification of the insured for pricing purposes, the insurance company's internal mortality, lapse, and retention values.

In accordance with an embodiment, the present invention as aforesaid provides the owner/insured with a low-cost option on life insurance policy while retaining value and benefits associated with whole, convertible term and/or universal life insurance policy for the insured. This allows a low-cost coverage while providing death benefits to the owner/insured. Additionally, the owner/insured can reassess at the end of the term his or her options as to the insurance policy and its value to him or her.

In accordance with an embodiment, the present invention as aforesaid also enables the insured/owner to use the present invention as a financial tool to create a reverse life settlement on any existing life insurance policies. The end result is that the insured is paid a certain sum payment for their policies with the added benefit of the policy being financed to a time certain period or to the maturity of the insured. The financing of existing policies allows the insured to continue to receive a scaled death benefit in allowing the life insurance policy to kept in force. The insured thus has varying options of receiving payment as a lump sum or on an installment basis while the program provider continues to pay future premiums. The insured/borrower has the option of a: (a) time certain loan date for payment of the amounts loaned, or (b) a guaranteed financing of the premiums with the loan date maturity occurring on the death of the insured. The insured thereby receives a certain guaranteed payment while in effect keeping his policy and any death benefit in-force (less the amounts due per the loan agreement upon the maturity of the loan or death of the insured).

In accordance with an embodiment, the present invention as aforesaid enables the insured/owner to use the present invention as a financial tool to obtain and/or create value for his or her insurance policy. The end result is that the owner/insured has obtained the benefit from maximum insurance coverage or capacity without incurring a substantial financial burden. Additionally, the insured has shifted future premium payments and mortality risk to the lender. That is, the insured has distributed the cost factor risk to the lender, i.e., the future payment obligations are borne by the lender. Further, the insured has distributed the lock-in risk to the lender. The insured is not locked-in or “stuck” with any unwanted or inflexible insurance policy. This may occur because the insured's status or needs may change over time, e.g., family matters, financial, estate considerations, etc.

In accordance with an embodiment of the present invention, the insured are high-net-worth seniors, particularly those over 70 years old and with one or more adverse medical conditions. It is estimated that approximately 80% of high-net-worth seniors have unused insurance capacity and qualify for increased life insurance coverage. Previously, high-net-worth-seniors were largely unable to convert such capacity into a financial asset and wealth-building tool. The present invention alters these dynamics and allows high-net-worth seniors to participate in the life insurance market.

In accordance with an embodiment of the present invention, a premium financing non-recourse loan product (LIF loan product) comprises a life insurance policy having a face amount and a premium that is issued in the name of a insured, and a non-recourse loan for financing the premium of the life insurance policy whereby the life insurance policy is the only collateral used for the non-recourse loan. The loan terms are determined in accordance with the insured's financial and medical information and the proceeds of non-recourse loan are used to pay the premium of the life insurance policy. The life insurance policy is assigned to a credit facility or program provider providing the loan as a collateral.

In an accordance with an embodiment of the present invention, the loan amount of the LIF loan product as aforesaid is determined in accordance with the insured's ability to repay the loan and the value of the life insurance policy at the end of a loan term using predictive arbitrage. Preferably, the terms of the loan require the insured be over 70 years old with an adverse medical condition and have a life expectancy of 180 months or less. It is also preferred for the insured to have assets valued in excess of one million dollars.

In accordance with an embodiment of the present invention, a method for administering a premium financing non-recourse loan product (the LIF loan product) comprises the steps of determining the premium and a face amount of a life insurance policy for a qualified insured and financing the premium of the life insurance policy using the life insurance policy as the only collateral for a non-recourse loan. The non-recourse loan is based on the qualified insured's financial and medical information. The insured assigns the life insurance policy as a collateral to a credit facility providing the non-recourse loan and the proceeds of the non-recourse loan is used to pay the premium of the life insurance policy. Preferably, the step of financing comprises determining the qualified insured's ability to repay the loan based on the value of the life insurance policy at loan term using predictive arbitrage. In accordance with an aspect of the present invention, the terms of the loan require the insured be over 70 years old with an adverse medical condition and have a life expectancy of 180 months or less. It is also preferred for the insured to have assets valued in excess of one million dollars.

In accordance with an embodiment of the present invention, the administering method as aforesaid additionally comprises the step of issuing the life insurance policy in the name of the qualified insured.

In accordance with an embodiment of the present invention, the non-recourse loan will be satisfied by one of the following: the insured or a beneficiary of the life insurance policy satisfying the non-recourse loan to the credit facility; selling the life insurance policy at the end of a loan term in a life settlement market; or the insured waiving rights to the life insurance policy, thereby transferring the ownership of the life insurance policy to the credit facility.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the specific concepts and embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following detailed description, given by way of example, and not intended to limit the present invention solely thereto, will be best be understood in conjunction with the accompanying drawings:

FIGS. 1A-1B depict a flow chart describing the premium financing process in accordance with an embodiment of the present invention; and

FIG. 2 is a diagram detailing the relationship between parties in financing and administering the LIF loan product in accordance with an embodiment of the present invention.

### DETAILED DESCRIPTION OF THE EMBODIMENTS

In accordance with an embodiment of the present invention, the method is a non-collateralized based program allowing for a 2-5 year premium financing using only life insurance policies as asset backed collateral (or “LIF” loan product). In accordance with an aspect of the present invention, the inventive method incorporates a financial and insurance underwriting based on insured/owner's financial and insurance capacity. The inventive product and method can utilize a known or proprietary insurance arbitrage to create a predictive program enabling the credit facility to determine and lend funds to a qualified borrower. The qualified borrower uses the borrowed funds or proceeds of the non-recourse loan to pay life insurance premiums.

The present invention is based on risk analysis or distribution of risk from the insured to the program provider. The insured can fully utilize his or her insurance capacity without incurring substantial financial burden or risk. The program provider lowers the cost or risk option to the insured in exchange for certain back-end value associated with the insurance policy. The program provider absorbs the insured's risks by its ability to create a value based arbitrage model and build ROI (return on investment) based on the back-ended value of the life insurance policy and deferred interest payment on the non-recourse loan.

In accordance with an embodiment of the present invention, the non-recourse loan product and method comprises the following aspects:
1. A step by step insurance underwriting process which effectuates the insurance analysis. Based on the specialty expertise of the Credit facility or program provider, the insured can shop for the best insurance in the insured's class.
2. Financially underwriting the insured and the policy, thereby enabling the Credit facility to assess and analyze the value of the policy and its ability to recover any amounts loaned out.
3. Medically underwriting the insured by utilizing an independent medical opinion, such as AVS, 21^{st} Services, etc., as to life expectancy in addition to internal evaluation of the insured. This advantageously enables the present invention to effectively assess the risk-arbitrage components, which can be used to determine the value of the policy at the end of term and at any fixed point in time, including maturity.
4. Utilization of a Portfolio theory to generate a broad model of future ability to pay, future value, maturity, and revenues derived from such portfolio of premium financed life insurance policies. Accordingly, the present invention underwrites each case or policy as a function of an over-all approach (that is among the portfolio of policies, money will be made and lost on some policies, some policies will be surrendered, the non-recourse loan will be repaid on some policies, etc.).

Based on the above, the insured gets the ability to not only have low-cost insurance, but also the potential to derive value on their policy at the end of the term.

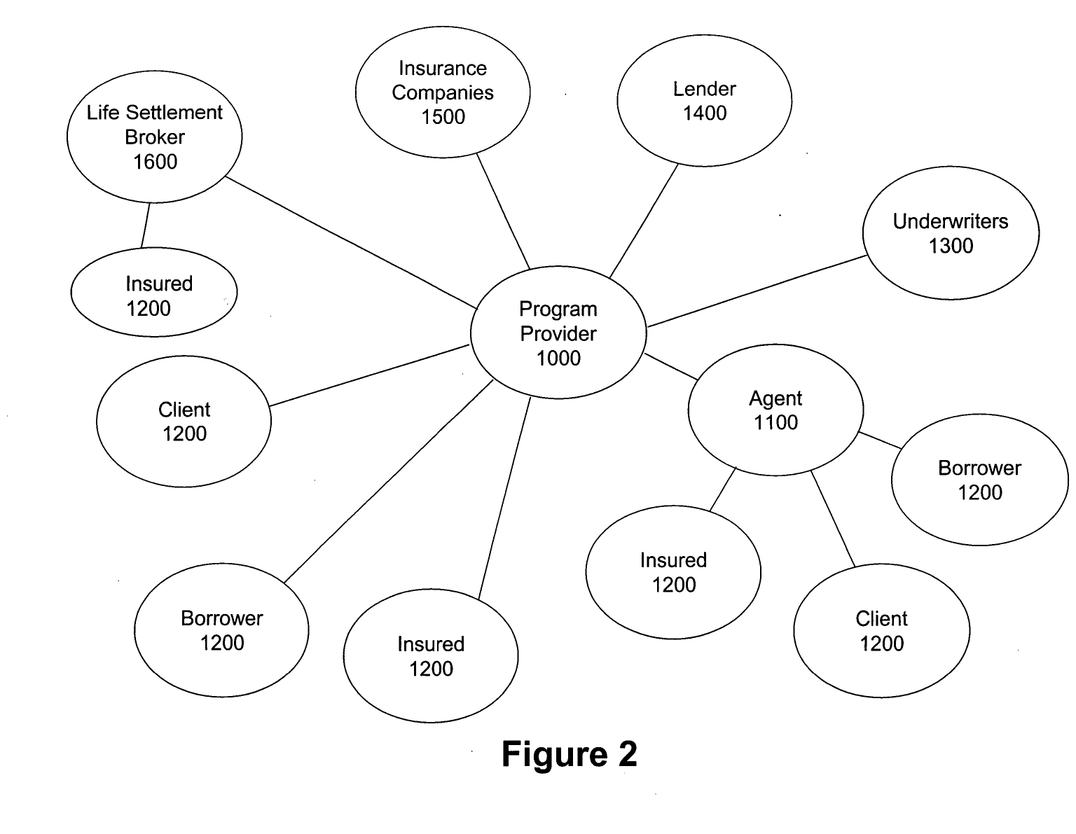

Turning now to FIG. 2, which illustrates various interactions between several entities involved in establishing the program of the present invention, the program provider 1000 can deal directly with all parties. For example, the program provider 1000 can meet with the client/borrower/insured 1200 to discuss and implement the program of the present invention. The program provider 1000 can also deal with an agent 1100 that represents the client/borrower/insured 1200.

The program provider 1000 obtains bids from insurance companies 1500 for the client/borrower/insured 1200. The program provider 1000 supplies financial and insurance information to underwriters 1300 who analyze and determine whether the client/borrower/insured 1200 qualifies for the loan product of the present invention. The program provider 1000 also deals with the lender 1400 who issues the loan product of the present invention and the life settlement broker 1600 who attempts to secure the best possible price for the sale of the life insurance policy at the end of the term of the loan.

The Program

In accordance with an embodiment of the present invention, the program provider, such as Capital Credit Group, Inc. provides a credit facility to allow for the financing of premiums on life insurance policies. By assessing the needs of the individual client, the program of the present invention provides new financial tools for use by the client, whereby, for example, the client can borrow funds necessary to maintain the required premiums on a life insurance policy. The program is customizable and flexible as to terms to suit the clients' needs. The life insurance policy is used as minimum sufficient collateral against the non-recourse loan, thereby allowing the insured to take full advantage of the amount of life insurance they can deploy without the costs. The present invention allows the policy owner to maximize their insurance capacity and provides tremendous add-on value to their financial assets.

The policy owner retains ownership of the insurance policy during the term of the non-recourse loan with various options at the end of the term of the loan. The policy owner can maximize any asset value for the policy. The program provider can also assist the policy owner in getting maximum value and benefits for their policy at the end of the term.

The program of the present invention is designed for those qualifying insureds who show the need and capacity to underwrite policies necessary for their financial and estate planning needs. For example, the target client group is those who have a need to create a low cost option which allows for financial flexibility in carrying a Life Policy. The present invention enables the insured can use the net loan proceeds and premiums for other more immediate financial needs. Accordingly, the present invention provides the insured with a low cost method of maintaining life insurance, while allowing for financial planning to a future point in time when there is more visibility and time-value as to the insured's needs for such a life insurance policy. In accordance with an embodiment of the present invention, an affiliation with operating Trust companies, such as a South Dakota Trust Administrator can be used to oversee any Trust set-up and maintenance.

The LIF products of the present invention are designed to capitalize on the varying underwriting standards historically endemic to the life insurance industry. Although insurance companies develop and apply strict, underwriting standards, they also often cope with fluctuating internal pressures to sell policies and generate near-term income.

Arbitrage opportunities can occur when policies written for older adults (in this case older seniors with medical issues) are influenced by insurance companies' varying market force which allows a competitive premium underwriting environment. It is appreciated that the arbitrage phenomenon enhances the program provider's business opportunity, as are brought to the market and placed with an insurer that is willing to issue, at extremely favorable rates.

How the Program Works

In accordance with an embodiment of the present invention, the insured generally has the option of electing a 2-5 year premium financing. The present invention customizes the terms and conditions of the non-recourse loan for each client, thereby allowing tremendous flexibility. Pricing of the program of the present invention is based principally on the size of the insurance policy and the term of the non-recourse loan selected. For example, the insured can elect to finance the premiums for a predetermined period, such as a two year premium finance with a renewal option. In accordance with an embodiment of the present invention, the program provider upon renewal will pre-pay and loan out future premiums for the renewal term. It is appreciated that the renewal term will extend out an additional term for the same term years as the original term. Such a renewal option, which is generally applied for at the time of the original loan term, can incur an additional prepayment fee, e.g., 1% per year prepayment of the amount loaned.

In accordance with an embodiment of the present invention, the premiums are pre-paid into the policy by the program provider utilizing a note and a collateral assignment of the policy to secure the note. It is appreciated that no other means of collateral is required. In accordance with an aspect of the present invention, the insured pays a contingent right fee, e.g., a predetermined percentage of the face value (depending on the terms) which is deferred and made a part of the loan. In accordance with another aspect of the present invention, the insured also pays interest on the amount loaned at a predetermined fixed or variable rate (pegged to the AFR rates as issued by the Internal Revenue Service), of which a certain portion, e.g., 0.5-3%, is preferably prepaid. The remaining percentage is deferred interest, payable at the end of the term of the policy.

In accordance with an exemplary embodiment of the present invention, the insured can prepay the non-recourse loan after a predetermined period, e.g., one year (pro-rated penalty for such prepayment). In accordance with an aspect of the present invention, the insured pays a service or loan origination fee based on the predetermined percentage, e.g., 5%, of the amount loaned which is preferably deferred and made a part of the non-recourse loan.

In accordance with an embodiment of the present invention, once an insured policy is selected from life insurance policies and acceptable terms for the non-recourse loan are reached between the insured/policy owner and the program provider, the insured reviews and signs a Term Sheet reflecting the loan terms and conditions. After final terms and conditions of the premium financing are established, it can be submitted to the policy owner and/or insured for review by their advisor. In accordance with an embodiment of the present invention, the insured provides the lender with documents necessary for proper closing of the non-recourse loan, including collateral assignment and other documents necessary to effect any obligations at the end of the term of the loan. At closing in according with an embodiment of the present invention, the insured/borrower pays the up-front interest component and the processing fee.

In accordance with an embodiment of the present invention, the LIF products are available through independent financial planners, insurance brokers and other financial services professionals. The following are exemplary LIF loan products of the present invention: a) LIF 2: a fixed, twenty seven month life insurance premium financing commitment, b) LIF 3: a fixed, three year life insurance financing commitment, c) LIF 4: a fixed, four year life insurance premium financing commitment; and d) LIF Reverse: a combination life settlement payment with a fixed certain or till maturity premium financing commitment. The program provider pre-pays annual premiums to the insurer for the entire term of the LIF loan, thus guaranteeing the borrower/insured coverage throughout the term of the loan.

Collection and Repayment Options

At the end of the term of the loan, the insured has several options. In accordance with an embodiment of the present invention, the insured can repay the loan principal, the Contingent Rights Fee (e.g., approximately 3-8% of policy's face value determined by several factors that can include life expectancy, premium levels, the term of the LIF loan, etc.) and all loan origination and service fees. The insured or borrower buys out the program provider's contingent rights to the policy and becomes the full owner of the policy after repayment of the loan and the Contingent Rights Fee. In accordance with an embodiment of the present invention, the beneficiary of the policy can repay all such amounts due to the program provider, such as the principal, Contingent Rights Fee, loan origination and service fees. Hence, the beneficiary will become the full owner of the policy.

In accordance with an embodiment of the present invention, the insured/borrower can request the sale of the insurance policy in the life settlement market. Proceeds from the successful sale of the insurance policy are used to repay the loan and the Contingent Rights Fee, with the insured/borrower entitled to any excess proceeds. In accordance with an embodiment of the present invention, the insured pays a market-rate commission for arranging the sale of the policy to the program provider or its agent.

In accordance with an embodiment of the present invention, the insured/borrower can choose not to repay the non-recourse loan. In this case, the borrower/insured sells the policy to the program provider for a nominal amount, i.e., $1.00 plus the assumption of the amount financed. If the policy cannot be sold for more than the total amount due (principal plus interest and fees), the insured/borrower is not obligated to repay the loan and can “walk away” after enjoying low-cost, high value life insurance coverage for the term of the non-recourse loan. That is, the insured/borrower can “walk away” from the loan obligation because the pricing structure of the LIF loan product of the present invention has, in effect, created a situation in which the insured/borrower has obtained two years or more worth of coverage at little cost to the insured. The increase in the value of the life insurance policy as a future life settlement over the loan period has been essentially financed by the insured/borrower assuming the insurance policy can be sold at a price sufficient to repay the amounts due under the loans. In accordance with an aspect of the present invention, the insurance policy is liquidated at the best price available and the proceeds used insurance to satisfy obligations associated with the original non-recourse loan, or the policy is kept by the program provider as part of their life settlement portfolio until such time as is advantageous to liquidate the insurance policy to satisfy any obligations of the loan.

In accordance with an embodiment of the present invention, the insured can elect an option to pay the deferred interest to date and have the future premiums prepaid. Thus, the insured has effectively extended the term of the policy for another cycle.

In accordance with the embodiment of the present invention, the insured can as part of the LIF options or as an independent transaction, the reverse life settlement of a certain payout with the future financing of premiums and death benefits.

If, however, the insured dies during the term of the non-recourse loan, proceeds is generated from the insurance policy and used to pay the principal, interest and origination fees plus an early termination fee. All remaining funds are distributed to the insured's named beneficiary.

Life settlements, the sale of an insurance policy covering an older adult for more than the insurance policy's cash value, to an investor who keeps the policy alive until the death of the person on whose life the policy covers, offer an impressive investment opportunity when transactions are based on sound investing.

Traditionally, the life settlement buyer purchases a senior's policy (giving the selling owner immediate cash) and then keeps it in force until the original policy owner dies. When the policy ultimately pays out at the insured's death, the buyer (and new owner) receives the policy's face value. Life settlement pricing is based mainly on the insured's estimated life expectancy, derived primarily from individual medical life expectancy assessments performed by independent, third party firms.

With respect to life settlements, when actual mortality accurately reflects life expectancy estimates at the time a policy is issued or purchased at a later date in the secondary market, actual financial returns meet predicted returns. Returns are calculated based on a policy's face value pay-out amount less the sum of the life settlement amount paid to the insured and any premiums that are paid to maintain the policy in good standing over the insured's remaining life. A portfolio of soundly underwritten life settlements would be expected to mature on or close to the average mean life expectancy predictions, creating a relatively predicable financial return.

Insurance companies develop and apply underwriting standards to determine whether and at what face amounts and premium levels individuals are eligible for various types of life insurance coverage. For the most part, they use the same underwriting standards that life settlement firms use in assessing life expectancy. However, insurance companies also cope with industry-wide and internal pressures to sell policies and generate near-term income.

Arbitrage opportunities as described above often occur when policies written for older adults are driven by market forces and influenced by differing objectives, by insurance companies' regarding new policy and new premium volume. These industry practices which have been ongoing for decades, enhance the program provider's business opportunity, as policies are placed and underwritten in a very structurally competitive and non-homogeneous environment.

The program provider works with borrowers to capitalize on such conditions to create cases where favorable dynamics prevail, leading to what can be expected to be profitable life settlement opportunities when LIF products come to term and the borrowers select a repayment option involving the sale of the policy into the life settlement market.

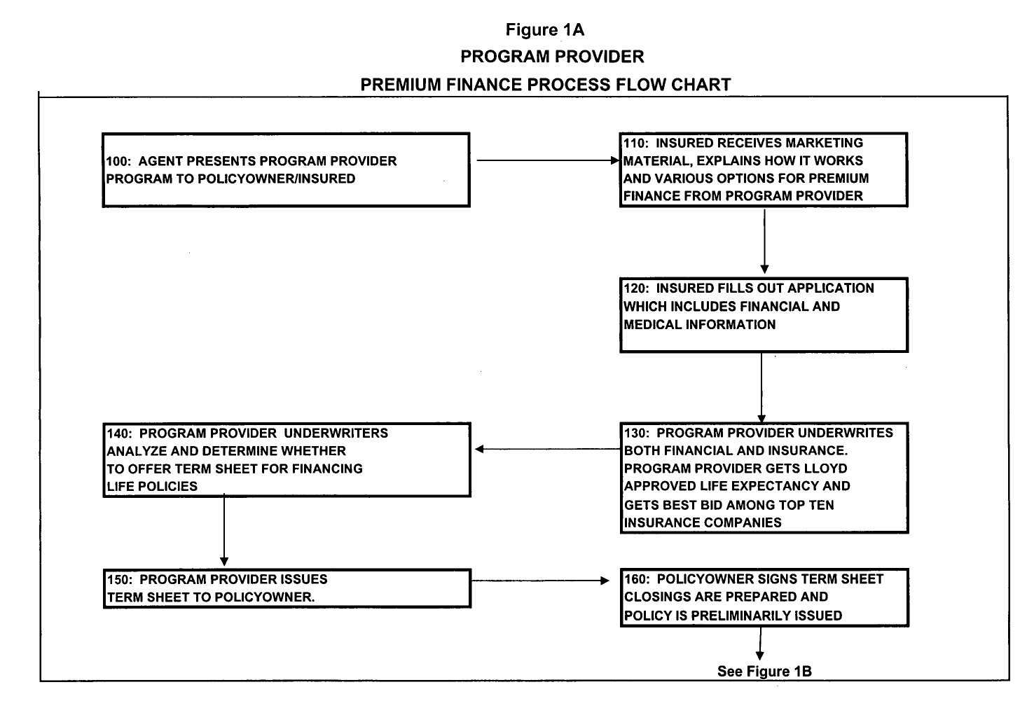

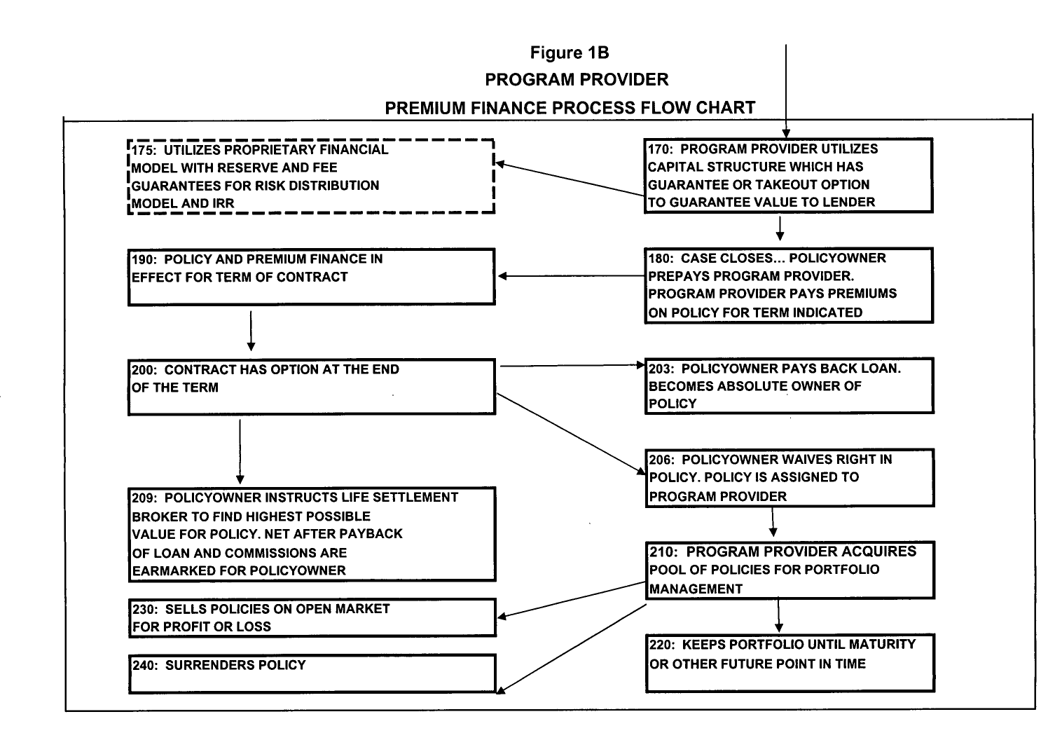

Turning now to FIGS. 1A-1B, there is illustrated a flow chart describing the premium finance process in accordance with an embodiment of the present invention:

Application Process

An agent 1100 presents the premium financing program of the present invention, to a potential client 1200 (i.e., policy owner/insured) in step 100 and provides the client 1200 with marketing materials, explaining the program and various premium financing options available from the program provider 1000 in step 100. If the policy owner/insurance client 1200 decides to proceed with the premium financing of the present invention, the client 1200 fills out an application which includes financial and medical information in step 120.

That is, the client 1200 fills out a financial application which includes documentation as to the client's financial status. Also, the application can include but not limited to policy information, documentation as to tax returns, possibly corporate returns. The client 1200 fills out medical information forms which allow for insurance underwriting, and fills out proper forms which allow for an approved third-party medical evaluation.

Underwriting

The program provider 1000 underwrites both the non-recourse loan and insurance policy. The program provider determines the life expectancy of the client, preferably Lloyd approved life expectancy reports. The program provider 1000, either working with client's advisor or through its own advisors, gets the best bid available for procurement of an insurance policy in step 130. Preferably, the program provider 1000 selects the best bid from the top ten life insurance companies 1500.

Underwriters 1300, preferably affiliates with the program provider, analyze the policy and other relevant information to determine whether to offer a term sheet for financing the premiums of the policy in step 140. Financial and medical underwriting allows the program provider to, through a known or proprietary evaluation model, determine the value of the policy at the end of its term, and the probability of such value. This allows the program provider 1000 to determine the financial or payback viability of non-recourse loan.

In accordance with an embodiment of the present invention, underwriting standards are established which allow program provider 1000 to work with borrowers 1200 to initiate high face value life insurance policies that life settlement brokers can expect to find highly marketable as life settlements at loan termination. Accordingly, the LIF product is generally limited to individuals who:
1) Have reached age 70+, have a life expectancy of 144 months or less and one or more adverse medical conditions,
2) Possess assets in excess of $1 million as the higher the personal wealth, the greater the need for higher face value life insurance coverage; and
3) Have unused insurance capacity, and would benefit by working with their advisors and the program provider to add pre-selected insurance assets consistent or proportionate with their financial situation that meet all requirements for a profitable sale into the life settlement market when the non-recoverage loan comes due.

The market of eligible borrowers is significant, and will grow larger as the U.S. population ages. With the development of the life settlement market and the related increased awareness of the “hidden asset” within life insurance policies, more advisors now include life settlement alternatives in their solutions to high net worth clients.

It is estimated that 20% of individuals who meet age and financial eligibility criteria for the LIF product also meet the 144-month life expectancy criteria at age 70. However, with each succeeding year, the percentage increases, as increased age brings overall life expectancy norms to bear and a higher percentage of seniors within the 144-month life expectancy band. Also, it is estimated that by the time they reach age 77-80, approximately 80% would be eligible. Accordingly, approximately 200,000 households in the US are potentially currently eligible candidates for the LIF products of the present invention.

When applicable, the program provider and designees will underwrite the existing policy value in order to work with the advisor and client to determine terms and reverse life settlement of any existing policies.

Issuance of Policy

Once the client or insured 1200 is approved for financing, the program provider 1000 issues a term sheet to the client 1200 which details the principal, deferred interest costs, deferred fees, the prepayment fee, and the like in step 150. Deferred fees can include but are not limited to an origination fee, contingent fee, and service fees. After the term sheet is signed by the client 1200, closing documents are prepared and the policy is preliminarily issued in step 160. Closing documents can include a note payable, collateral assignment, and any other documents that will allow for assignment and subsequent re-sale of the insurance policy. Preferably, the client 1200 also signs power of attorney documentation to allow the program provider to carry forward with future obligations which can include tracking and other servicing arrangements.

If the client is approved and agrees to a reverse life settlement, the program provider 1000 will issue a term sheet to the client 1200 which detail all the payouts and costs to the client 1200. After the term sheet, closing documents are prepared and issued.

Capital Structure

Several different Capital Structures are available for the lending arrangement. A value based analysis allows the program provider to utilize external or internal takeout guarantees on the lending pool in step 170. That is, the program provider 1000 utilizes capital structure which has probable takeout and reserve options, which enhances value to the lender. Takeout guarantees can be based on known or proprietary portfolio management, known or proprietary valuation structure, and known or proprietary fee structure. Preferably, the program facility utilizes a known or proprietary model to create a risk-distribution model using reserves and fees to enhance and increase the projected IRRs (internal rate of returns) in step 175. The pool management allows for incorporating various options in distributing value and risk.

Closing

If the application is in order, with an acceptable insurance policy, the program provider 1000 prepares a closing package which enters into the loan agreement with the client 1200 simultaneously with the purchase of the policy by the client in step 180. Documents in the closing package can include: the note and security loan agreement, including a schedule which spells out the terms of the loan; a term sheet of the loan transaction; the life insurance policy designating the program provider as a collateral assignee; a copy of the application and insurance policy; a recordation with the Insurance Company 1500 as to the acceptance of the collateral assignment on the indicated policy; Insured, Borrower and Beneficiary acknowledgement and cooperation as to any future obligation as to any potential life settlement (whether as a result of a directive or a “walk away”); medical records and the third party life expectancy estimate.

In accordance with an embodiment of the present invention, a trust administrator can be utilized to set up a trust or LLC structure. At the behest of the insured, the trustee acts as borrower for the loan. The documentation necessary for execution takes into account the ability to collateralize and create ownership in the policy on behalf of the lender. All trust documents and directives has the program providers named as the assignee with rights to the policy.

The policy is then issued and the client (now a policy owner/insured) 1200 signs the closing documentation which includes a non-recourse Note (collateralized only by the Policy itself). The insured 1200 prepays a portion of interest for length of loan term (a predetermined percentage, e.g., 0.5-3%, depending on loan structure). The program provider 1000 pays the premiums to the insurer 1500 to cover such amounts for the length of the loan (i.e., two years of premiums, if it is a two year loan term).

The program provider 1000 services and maintains the non-recourse loan, as well as monitors the insured 1200 and the policy premiums in step 190. Hence, the policy and premium finance are in effect for the term of the contract. The program provider 1000 is obligated to pay extra premiums if amount originally paid is not sufficient. The program provider 1000 also provides notices for repayment at the appropriate time on a per contract basis. Pursuant to the contract terms, insured 1200 notifies the program provider 1000 of its plan to exercise any of its options.

At the end of the contract term, there are several options that the insured 1200 can exercise in step 200.

Policy Owner Options

At the end of the term, the insured 1200 can pay back the non-recourse loan including all deferred interest and deferred fees and become the absolute owner of the policy in step 203. At such time, the program provider 1000 relinquishes the collateral assignment.

Alternatively, the insured 1200 can waive all rights to the policy, which allows the program provider 1000 to enforce its collateral assignment and become the owner of the policy in step 206.

Additionally, the insured 1200 can instruct a life settlement broker, such as Allsettled Group, to shop the marketplace and try to find the best value for the insurance policy in step 209. From the net proceeds (after broker fees), any balance left after paying off the non-recourse loan goes to the insured 1200. If the insurance policy cannot be sold to cover the amounts due, including the Contingent Rights Fee, this contributes to a Borrower default and the sale of the policy to the program provider 1000 for a nominal amount, i.e., $1.00 plus the assumption of the amount due after which the program provider arranges for the sale of the insurance policy to satisfy the outstanding obligations.

If, however, the insured 1200 dies during the term of the non-recourse loan, proceeds will be generated from the insurance policy and distributed to pay the principal, interest and origination fees plus an early termination fee. All remaining funds will be distributed to the insured's named beneficiary. In the event an insured 1200 passes away, a request for a copy of the death certificate is filed with the appropriate governmental office. Typically the family of the insured also submits a death certificate to the program provider 1000. The death certificate is then filed with the insurance company 1500 and a request for a settlement of the policy is made. The settlement status is followed up until the proceeds of the policy are paid to the program facility and others as deemed appropriate. It is appreciated that the insurance companies 1500 have an incentive to pay promptly as most states require insurance companies to pay on claims that take more than 30 days to settle.

In accordance with an embodiment of the present invention, the LIF products feature an attractive and strategic pricing structure, creating minimal credit risk regardless of the option chosen by the policy-holder when the LIF loan comes to term. The LIF products are structured to enable the program provider to derive an assortment of cash flows on each LIF loan written, the most substantial of which is a Contingent Rights Fee generally equal to 3% to 8% of the face value of the policy. In addition, policy owners pay minor up-front interest and processing fees at loan closing, and more substantial interest payments, loan service fees, and contingent fees when loans are repaid.

Policies Assigned to Credit Facility

The program provider 1000 creates a portfolio pool of all policies assigned to it at the end of the loan terms in order to manage the policies. The capital structure and guarantees provide the program provider 1000 with various options in managing the policies. The program provider 1000 can decide to surrender the policy for no value in step 240, decide to keep policy and maintain policy either until maturity or at any point in time which maximizes value and return on investment (ROI) in step 220, or enter the marketplace to get best possible value for the insurance policy in step 230.

Policies that are underwritten with sufficient underlying values are ideal candidates for value in the life settlement market by the life settlement broker as 1) the program provider 1000 has worked with the borrower 1200 to secure a policy that could possibly be sold in the life settlement market, and 2) life expectancy, the primary pricing variable of a life settlement is more predictable in the cases of elderly seniors with some adverse health, allowing the program provider 1000 (in conjunction with the life settlement broker excellent visibility as to the eventual sale price of the policy). It is expected that sales of policies underlying the LIF products will occur in approximately 80% its LIF loan transactions.

In accordance with an embodiment of the invention, the program provider 1000 targets seniors (age 70 or more) as clients, which has one or more adverse medical conditions and a life expectancy of 180 months (15 years) or less. Arbitrage opportunities and life settlement pricing are enhanced for older seniors with medical conditions. A policy owner/insured 1200 with assets valued in excess of $1 million and has unused insurance capacity would benefit from the present invention. The present invention provides these older seniors with an opportunity to add insurance assets consistent or proportionate with their financial status. Furthermore, the program provider 1000 works with the insured's advisors 1100 to identify and judiciously selects an insurance policy from a competitively “shopped” insurance policy that provides the basis for value of the insurance policy, when sold to repay the non-recourse loan at the end of the term.

The following is an exemplary loan structure in accordance with an embodiment of the present invention, a seventy five year old borrower 1200 with an adverse medical condition and net worth in excess of $15 million seeks $10,000,000 in life insurance coverage (universal or term) and wants to finance the premiums with a fixed 27 month loan. The program provider assists the borrower 1200 in identifying a $10 million face value policy for purchase, with annual premiums of approximately $500,000, translating to $1,125,000 over a 27-month (2.25 year) term. The program provider 1000 lends the policy owner (borrower 1200) the following amounts: upfront payment of premiums of $1,125,000; origination and administrative fees of approximately 5% of the premiums financed; interest at the prevailing AFR rate (approximately 2.92% in the example) less the up-front interest of approximately 0.5% of the premiums financed; and a Contingent Rights Fee of approximately $500,000 (5% of the face value of this particular underlying policy).

At the end of twenty-seven months, the amount due on such a non-recourse loan is approximately $1,734,575. Flexible arrangements can extend this period another two years in some cases. Additionally, the borrower 1200 collaterally assigns rights to ownership of the policy to the program provider 1000 at the outset of the loan (in the event that the borrower opts not to repay the non-recourse loan when due.

Using the sample premium financing transaction described above for a $10 million face value policy, high returns are evident as summarized in Table 1.

TABLE 1
BORROWER OPTIONS AND PRICING EXAMPLE FOR A 27-MONTH LOAN

| Option Selected by Policy Holder | Return on Investment | |
|---|---|---|
| 27 month loan is repaid: policy holder | $1,125,000 | (premiums due over 2.25 years) |
| assumes full ownership of policy | $56,250 | (misc. fees financed - approx. 5% of prems.) |
| | $71,702 | (interest financed at 2.92% APR) |
| | $1,252,952 | (total financed exclusive of CR Fee) |
| | $500,000 | (CR Fee) |
| | $1,752,952 | (total financed) |

| | |
|---|---|
| | Other amounts paid upfront by Borrower: |
| | $5,625 (interest paid upfront by Borrower) |
| | $1,500 (processing fee) |
| | Program Provider receives $1,752,952 (the amount |
| | financed), |
| | IRR to program provider: approximately 20%. |
| Loan is repaid; policy is sold on policy | Same as above, |
| holder's behalf in life settlement market | Based on a gross offer of 21% of the face value of the |
| | policy, or $2,100,000, program provider would receive |
| | $1,752,952 (the amount financed), life settlement broker |
| | would receive $100,000, and the Borrower would receive |
| | $247,048 as Policyholder is entitled to excess proceeds in |
| | excess of loan repayment. |
| | IRR to program provider: approximately 20% |
| Loan is not repaid. Policy purchased by | Policy will be marketable at such a price as to generate |
| Credit Facility for $1.00 | proceeds sufficient to repay all amounts due on the loan. |
| | Program provider would expect to sell such a policy for |
| | between $1,450,000-1,750,000 |
| | IRR to program provider: approximately 10-15%. |

In accordance with an embodiment of the present invention, a premium financing non-recourse loan product (LIF loan product) comprises a life insurance policy having a face amount and a premium that is issued in the name of a insured, and a non-recourse loan for financing the premium of the life insurance policy whereby the life insurance policy is the only collateral used for the non-recourse loan. The loan terms are determined in accordance with the insured's financial and medical information and the proceeds of non-recourse loan are used to pay the premium of the life insurance policy. The life insurance policy is assigned to a credit facility or program provider providing the loan as a collateral.

In an accordance with an embodiment of the present invention, the loan amount of the LIF loan product as aforesaid is determined in accordance with the insured's ability to repay the loan and the value of the life insurance policy at the end of a loan term using predictive arbitrage. Preferably, the terms of the loan require the insured be over 70 years old with an adverse medical condition and have a life expectancy of 180 months or less. It is also preferred for the insured to have assets valued in excess of one million dollars.

In accordance with an embodiment of the present invention, a method for administering a premium financing non-recourse loan product (the LIF loan product) comprises the steps of determining the premium and a face amount of a life insurance policy for a qualified insured and financing the premium of the life insurance policy using the life insurance policy as the only collateral for a non-recourse loan. The non-recourse loan is based on the qualified insured's financial and medical information. The insured assigns the life insurance policy as a collateral to a credit facility providing the non-recourse loan and the proceeds of the non-recourse loan is used to pay the premium of the life insurance policy. Preferably, the step of financing comprises determining the qualified insured's ability to repay the loan based on the value of the life insurance policy at loan term using predictive arbitrage. In accordance with an aspect of the present invention, the terms of the loan require the insured be over 70 years old with an adverse medical condition and have a life expectancy of 180 months or less. It is also preferred for the insured to have assets valued in excess of one million dollars.

In accordance with an embodiment of the present invention, the administering method as aforesaid additionally comprises the step of issuing the life insurance policy in the name of the qualified insured.

In accordance with an embodiment of the present invention, the non-recourse loan will be satisfied by one of the following: the insured or a beneficiary of the life insurance policy satisfying the non-recourse loan to the credit facility; selling the life insurance policy at the end of a loan term in a life settlement market; or the insured waiving rights to the life insurance policy, thereby transferring the ownership of the life insurance policy to the credit facility.

While the present invention has been particularly described with respect to the illustrated embodiments, it will be appreciated that various alterations, modifications and adaptations may be made on the present disclosure, and are intended to be within the scope of the present invention. It is intended that the appended claims be interpreted as including the embodiments discussed above, those various alternatives, which have been described, and all equivalents thereto.

1. A method for financing the premium of a life insurance policy, comprising the steps of:
qualifying a prospective insured for premium financing based on an insured's financial and medical information;
financing the premium of said life insurance policy using said life insurance policy as only collateral for a non-recourse loan;
assigning said life insurance policy as a collateral to a credit facility providing said non-recourse loan; and
paying the premium of said life insurance policy using the proceeds of said non-recourse loan.

2. The method of claim 1, wherein said life insurance policy is an existing life insurance policy of said insured; and further comprising the step of providing a reverse life settlement of said existing life insurance policy.

3. The method of claim 1, further comprising the steps of determining a premium and a face amount of said life insurance policy for a qualified insured and issuing said life insurance policy in the name of said qualified insured.

4. The method of claim 1, wherein the step of qualifying comprises the step of determining said prospective insured's ability to repay said non-recourse loan based on the value of said life insurance policy at a loan term using predictive arbitrage.

5. The method of claim 1, wherein the step of qualifying comprises the step of determining the age, medical and financial condition of said prospective insured.

6. The method of claim 5, wherein the step of qualifying comprises the step of qualifying said prospective insured as said qualified insured if said prospective insured has at least one of the following attributes: over 70 years old with an adverse medical condition, a life expectancy of 180 months or less, and assets valued in excess of one million dollars.

7. The method of claim 1, further comprising the step of pooling life insurance policies and non-recourse loans of qualified insured into a portfolio.

8. The method of claim 1, further comprising the step of terminating said assignment of said collateral by satisfying said non-recourse loan by said qualified insured or a beneficiary.

9. The method of claim 1, further comprising the step of selling said life insurance policy at the end of a loan term in a life settlement market to satisfy said non-recourse loan.

10. The method of claim 1, further comprising the step of said qualified insured waiving rights to said life insurance policy, thereby transferring the ownership of said life insurance policy to said credit facility.

11. The method of claim 1, further comprising the step of satisfying said non-recourse loan with the proceeds of said life insurance policy upon the death of said qualified insured during the term of said non-recourse loan.

12. A premium financing non-recourse loan product, comprising:
a life insurance policy in the name of a insured or trust, said life insurance policy having a face amount and a premium; and
a non-recourse loan for financing said premium of said life insurance policy using said life insurance policy as only collateral for said non-recourse loan in accordance with said insured's financial and medical information, and proceeds of said non-recourse loan being used to pay the premium of said life insurance policy; and
wherein said life insurance policy is assigned to a credit facility providing said non-recourse loan as a collateral and paying the premium of said life insurance policy using the proceeds of said non-recourse loan.

13. The premium financing non-recourse loan product, wherein said life insurance policy is an existing life insurance policy of said insured or trust; and further comprising the step of providing a reverse life settlement of said existing life insurance policy.

14. The premium financing non-recourse loan product, wherein said life insurance policy is a new insurance policy issued to said insured or trust.

15. The premium financing loan product of claim 12, wherein a loan amount of said loan is determined in accordance with said insured's ability to repay said loan and the value of said life insurance policy at a loan term using predictive arbitrage.

16. The premium financing loan product of claim 12, wherein said life insurance policy is issued to said insured having at least one of the following attributes: over 70 years old with an adverse medical condition, a life expectancy of 180 months or less, assets valued in excess of one million dollars, such that said life insurance policy is marketable in a life settlement market.

17. A method for administering a premium financing non-recourse loan product, comprising the steps of:
financing a premium of said life insurance policy using a life insurance policy as only collateral for a non-recourse loan based on said qualified insured's financial and medical information;
assigning said life insurance policy as a collateral to a credit facility providing said non-recourse loan; and
paying the premium of said life insurance policy using the proceeds of said non-recourse loan.

18. The method of claim 1, wherein said life insurance policy is an existing life insurance policy of said insured; and further comprising the step of providing a reverse life settlement of said existing life insurance policy.

19. The method for administering a premium financing loan product of claim 17, wherein the step of financing comprises the step of determining said qualified insured's ability to repay the loan based on the value of said life insurance policy at loan term using predictive arbitrage.

20. The method for administering a premium financing loan product of claim 19, further comprising the step of satisfying said non-recourse loan by one of the following: said insured or a beneficiary of said life insurance policy; selling said life insurance policy at the end of a loan term in a life settlement market; or waiving rights to said life insurance policy by said insured, thereby transferring the ownership of said life insurance policy to said credit facility.
